(19) United States
(12) Patent Application Publication
(10) Pub. No.: US 2025/0068494 A1
(43) Pub. Date: Feb. 27, 2025

(54) FORECASTING INDUSTRIAL ASSET FAILURES

(71) Applicant: Aveva Software, LLC, Lake Forest, CA (US)

(72) Inventors: Peter Burgardt, Northbrook, IL (US); William Bielke, Chicago, IL (US)

(73) Assignee: Aveva Software, LLC, Lake Forest, CA (US)

(21) Appl. No.: 18/808,258

(22) Filed: Aug. 19, 2024

Related U.S. Application Data
(60) Provisional application No. 63/534,196, filed on Aug. 23, 2023.

(51) Int. Cl. G06F 11/00

(52) U.S. Cl. CPC G06F 11/004; G06F 2201/81

(57) ABSTRACT

Forecasting industrial asset failures is described. A system determines a data start value associated with an industrial asset at a data start time. The system determines a data end value associated with the industrial asset at a data end time. The system estimates a failure time when a trend projected from the data start value through the data end value will reach a failure limit value. The system determines a distance to failure based on the failure limit value and the data end value. The system outputs a failure forecast, associated with the failure time and the distance to failure, for the industrial asset.

### CROSS REFERENCE TO RELATED APPLICATION

This application claims priority under 35 U.S.C. § 119 or the Paris Convention from U.S. Provisional Patent Application 63/534,196, filed Aug. 23, 2023, the entire contents of which are incorporated herein by reference as if set forth in full herein.

### BACKGROUND

Analyzing operational trends for an industrial facility is time consuming. Each industrial asset can have many sensors and the industrial facility can include hundreds or thousands of industrial assets or equipment. This analysis issue is further multiplied when an enterprise has multiple industrial facilities spread across a wide geographical area. The amount of data these sensors generate is far too large to maintain very frequent physical monitoring and evaluation of each trend. Further complicating matters, only those operators who are familiar with the equipment are able to determine the risk from abnormal trends because each trend has its own units and failure limits, as shown by FIG. 1, which illustrates example trends 100 for equipment data depicted by a system for forecasting industrial asset failures, according to some embodiments.

There currently exist conventional forecasting systems that extrapolate a time to failure using sample trend data. However, these prior art systems are often found to be unreliable at forecasting equipment failure.

### BRIEF DESCRIPTION OF THE DRAWINGS

FIG. 1 illustrates example trends for equipment data depicted by a system for forecasting industrial asset failures, according to some embodiments.

FIG. 2 illustrates an example display portion depicted by a system that includes software configured to look for anomalies in data trends for forecasting industrial asset failures, according to some embodiments.

FIG. 3 illustrates an example alerts tab portion depicted by a system for forecasting industrial asset failures, according to some embodiments.

FIG. 4 illustrates an example graph where the time failure domain is emphasized by a system for forecasting industrial asset failures, according to some embodiments.

FIG. 5 illustrates an example graph where the unit failure domain is emphasized by a system for forecasting industrial asset failures, according to some embodiments.

FIG. 6 illustrates an example failure risk evaluation formula used by a system for forecasting industrial asset failures, according to some embodiments.

FIG. 7 illustrates example risk designation categories used by a system for forecasting industrial asset failures, according to some embodiments.

FIG. 8 illustrates an example graph of the time and distance risk assessments depicted by a system for forecasting industrial asset failures, according to some embodiments.

FIG. 9 shows an expected failure path for a linear trend in a graph depicted by a system for forecasting industrial asset failures, according to some embodiments.

FIG. 10 illustrates real world examples of a current trend in a graph's circular domains depicted by a system for forecasting industrial asset failures, according to some embodiments.

FIG. 11 illustrates an example contrast with a problem for conventional systems accurately predicting failure for changing trends for forecasting industrial asset failures, according to some embodiments.

FIG. 12 shows a comparison of a left risk representation with no unit weighting (conventional system) to a right risk representation with unit weighting as defined by a system for forecasting industrial asset failures, according to some embodiments.

FIG. 13 shows a modification to the risk assessment equation where the time to failure includes a minimum response time component used by a system for forecasting industrial asset failures, according to some embodiments.

FIG. 14 illustrates an example time to failure trend section on an analytics display depicted by a system for forecasting industrial asset failures, according to some embodiments.

FIG. 15 illustrates a block diagram of an example system for forecasting industrial asset failures, according to some embodiments.

FIG. 16 is a flowchart that illustrates an example computer-implemented method for forecasting industrial asset failures, according to some embodiments.

FIG. 17 is a block diagram illustrating an example hardware device in which the subject matter may be implemented.

### DETAILED DESCRIPTION

Prior art systems are often found to be unreliable because they only provide estimates of a time to reach a failure limit while not accounting for how close the overall trend is to the failure limit. Conventional forecasting systems perform poorly assessing the total risk of failure for problems which involve high/low rates of change or magnitude from the failure limit. For instance, conventional systems may estimate a time to failure for a temperature limit at 10 days for a current trend, while not considering that a one-degree temperature increase, which might occur as a variation in a process, could cause failure at any moment. Only accounting for the time to failure can often result in a high-risk asset improperly receiving a low priority ranking.

In some conventional systems, as the trend of one of an industrial asset's data points progresses toward a failure limit value, the slope of the data may change. In these systems, this slope change will cause the estimated time to failure to also change. This time to failure may indicate that according to current trends, the risk is now minimal because the time to failure has been significantly extended, such as from hours to days.

However, this conventional calculation ignores the unit (vertical) component of the data trend and how close the data is trending to the failure edge. Because the unit component is not accounted for, conventional systems typically downgrade important issues to the point where these issues may no longer be a considered a priority for review. Therefore, there is a need for systems and methods that provide for concurrent analyses of a large numbers of different types of processes and accurately prioritize the failure risk of each.

This disclosure is directed to systems and methods for normalizing failure risks into a single metric used across different equipment types so that a system user has a way to view the results of forecasting in a prioritized order that puts the most important information first. The system can enable a user to assess risk without looking at a trend chart for a specific tag, and can communicate risk for parameters with different units in the same way.

In some embodiments, a system determines a data start value associated with an industrial asset at a data start time. The system determines a data end value associated with the industrial asset at a data end time. The system estimates a failure time when a trend projected from the data start value through the data end value will reach a failure limit value. The system determines a distance to failure based on the failure limit value and the data end value. The system outputs a failure forecast, associated with the failure time and the distance to failure, for the industrial asset.

For example, a system determines that at noon on September 8th a feedwater pump had a water temperature of 144.9 degrees F. (Fahrenheit), and currently at noon on September 9th the feedwater pump has a water temperature of 145.0 degrees F., which is a general trend of an increase in 0.1 degrees F. over 1 day. The system projects the trend from the current water temperature of 145.0 degrees F. into the future and estimates that the feedwater pump's water temperature will reach the equipment failure temperature of 146.0 degrees F. in 10 days at noon on September 19^{th}. The time to failure that is remaining is 10 days from the data end time of noon on September 9^{th} to the projected failure time of noon on September 19^{th} out of a projected 11 days from the data start time of noon on September 8^{th} to the projected failure time at noon on September 19^{th}, which is a normalized remaining time to failure of 91% (10 days divided by 11 days). The remaining distance to failure is 1.0 degrees F. from the current temperature of 145.0 degrees F. to the failure limit value of 146.0 at noon on September 19^{th}, out of a projected total distance to failure of 22.0 degrees F. from the expected starting temperature of 124.0 degrees F. to the projected failure temperature of 146.0 degrees F., which is a normalized distance to failure of 5% (1.0 degrees F. divided by 22.0 degrees F.). Due to the extreme urgency assigned to the distance to failure for the temperature of the feedwater pump, and despite the low urgency assigned to the time to failure for the feedwater pump, the system outputs the highest priority for the failure risk for the feedwater pump.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. Operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

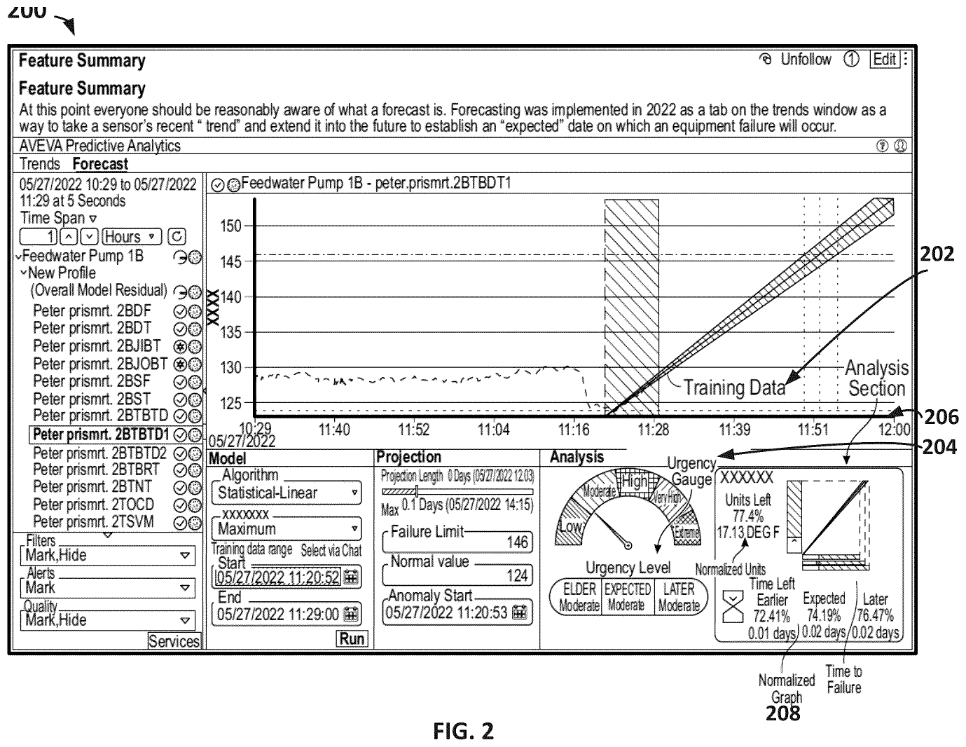

FIG. 2 illustrates an example display portion of a system 200, for forecasting industrial asset failures, and which includes software configured to look for anomalies in a data trend, according to some embodiments. The system 200 enables a user to select training data 202, select one or more points representing an anomaly on a trend, and to select a trend range. The system 200 can compare the training data against other sample data, and use the training data to train artificial intelligence models.

After being trained on training data 202, the system 200 can identify multiple anomalies and/or generate a list of the multiple anomalies on a dashboard. The system can project trends based on anomalies to forecast the times when the anomalies cause equipment failures, which triggers system alerts. The system 200 can display these alerts in conjunction with the forecast model, with each of the alerts corresponding to a discrete level of an urgency gauge 204.

The system 200 can execute a time normalization to normalize the forecast model in the time to failure 206 axis, and a unit normalization that normalizes the forecast model in a normalized graph 208 that depicts the normalized units 210 of measure axis, and an urgency calculation using the time normalization and the unit normalization to evaluate risk across a multitude of considerations.

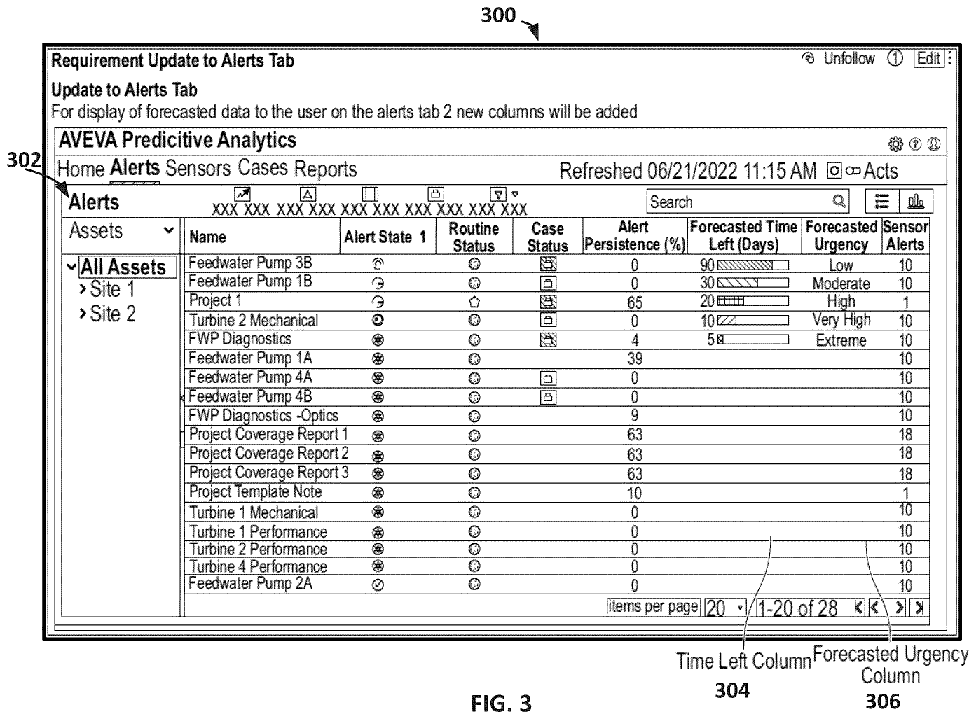

FIG. 3 illustrates an example alerts tab portion 302 of a system 300 for forecasting industrial asset failures, according to some embodiments. The alerts tab portion 302 includes a forecasted time left 304 column, such as days or hours remaining until equipment failure, which is normalized, and a forecasted urgency 306 column, which displays urgency in discrete levels, such as low, moderate, high, very high, and extreme. The assets represented in the forecasted time left 304 column are associated with the forecasted urgency 306 column, while the resulting columns and rows are categorizing which assets have the highest urgency.

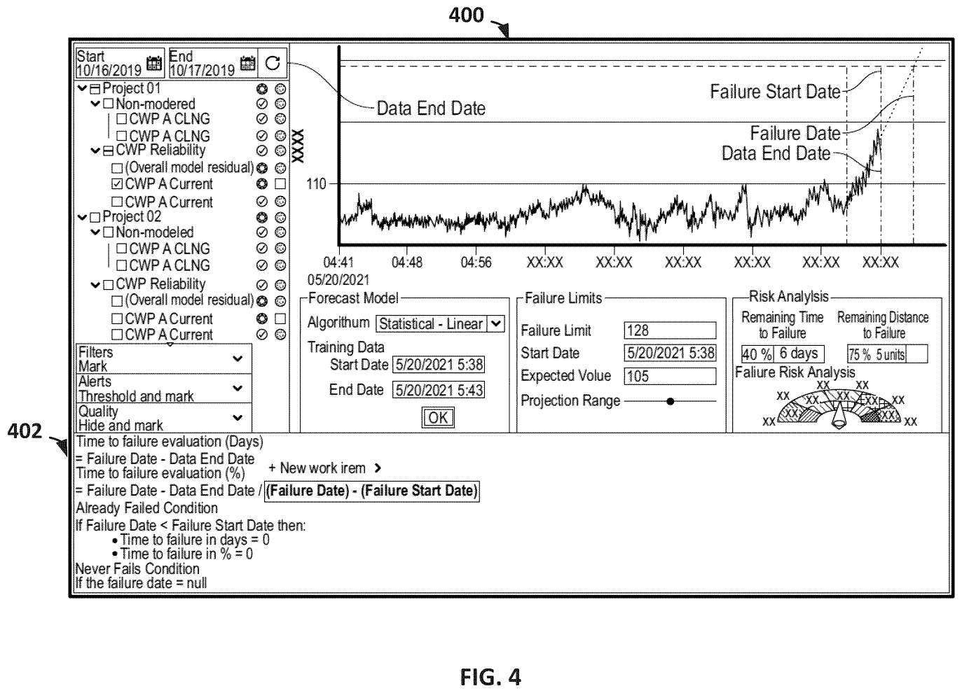

FIG. 4 illustrates an example graph 402 where the time failure domain is emphasized by a system 400 for forecasting industrial asset failures, according to some embodiments. The system 400 can project a trend to a failure limit and evaluate the time and the distance to the failure limit. The system 400 can break the trend into axis components, such as x axis components and y axis components. The system 400 can determine risk based on a separate analysis of each axis component, based on a distance to a failure limit on a trend in each axis direction. An axis direction includes a horizontal axis direction and/or vertical axis direction.

The system 400 can normalize the value of an axis component, which enables a system user to compare different equipment. The normalization enables risk analysis comparison of different equipment types to each other. Each axis component represents a failure domain. Normalizing in both directions gives a value between 0 and 1 (or 0% and 100%) for each axis component.

For the following example, the system 400 recorded the feedwater pump 1B's temperature as 105 degrees F. at 5:38:00 AM, and as 115 degrees F. at 5:43:00 AM, then projected the linear trend between these two data points to continue linearly until reaching 128 degrees F. at 5:46:20 AM. Although this example uses a specific trend and one specific type of projection to simplify the example calculations of time to failure and distance to failure, the system 400 can evaluate any type of trend, and make any number of any types of projections.

Continuing the example, the system 400 normalizes the time to failure through determining a numerator by subtracting the data end date, which may be referred to as a data end time, from a failure date, which may be referred to as a failure time, which is the date and time that the trend to is projected by the system 400 to reach a failure limit value, which is when equipment failure is expected to start occurring. In this example, the failure time is 5:46:20 AM and the data end time is 5:43:00 AM, so the numerator is determined to be the difference of 3 minutes and 20 seconds, or 3.33 minutes. Further to this example, the system 400 normalizes the time to failure through determining a denominator by subtracting the failure start date, which may be referred to as a data start time, from a failure date, which may be referred to as a failure time, which is the date and time that the trend to is projected by the system 400 to reach a failure limit value, which is when equipment failure is expected to start occurring. In this example, the failure time is 5:46:20 AM and the data start time is 5:38:00 AM, so the denominator is determined to be the difference of 8 minutes and 20 seconds, or 8.33 minutes.

The system 400 completes the normalization of the time to failure by dividing the determined numerator by the determined denominator, which in this example is 3.33 minutes divided by 8.33 minutes, which normalizes the remaining time to failure at 40%. This means that of the 8 minutes and 20 seconds that the trend is expected to traverse from the data start value to the failure limit value, 3 minutes and 20 seconds (which is 40% of 8 minutes and 20 seconds) remains to be traversed. The example graph 402 shows that the time domain (vertical lines) is 40% to failure.

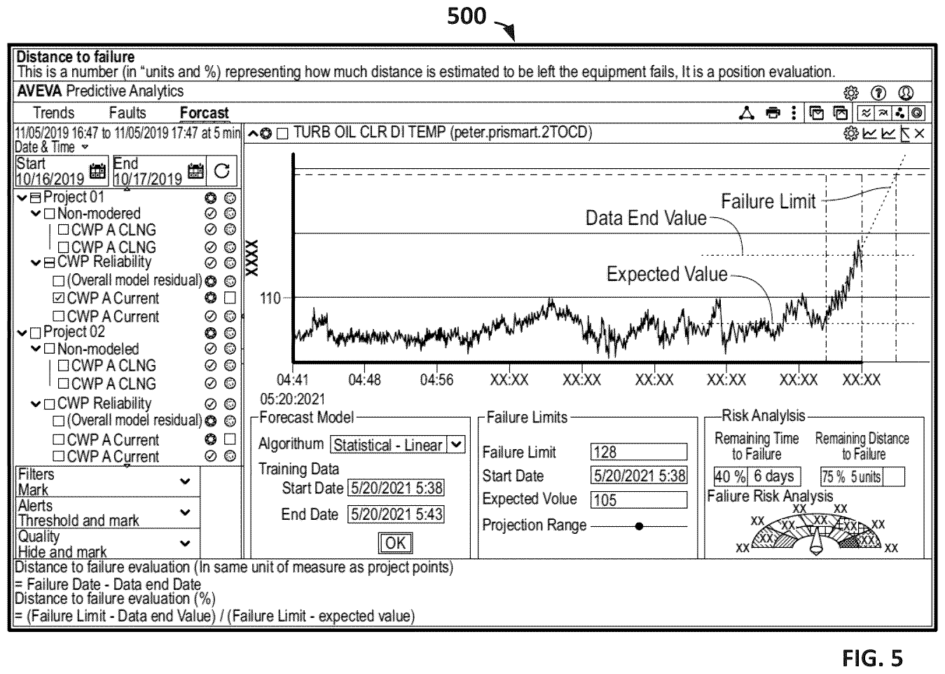

FIG. 5 illustrates an example graph where the unit domain is emphasized by a system 500 for forecasting industrial asset failures, according to some embodiments. The unit domain is also referred to herein as the distance to failure domain. Corresponding to the preceding example, the system 500 normalizes the distance to failure through determining a numerator by subtracting the data end value, from a failure limit, which may be referred to as a failure limit value, which is the value of the evaluated type of data which begins indicating equipment failure for the corresponding industrial asset, such as the feedwater pump 1B.

In this example, the failure limit value is 128 degrees F. and the data end value is 115 degrees F., so the numerator is determined to be the difference of 13 degrees F. Further to this example, the system 500 normalizes the distance to failure through determining a denominator by subtracting the expected value, which may be referred to as an expected data value, from the failure limit, which may be referred to as a failure limit value, which is the value of the evaluated type of data which begins indicating equipment failure for the corresponding industrial asset, such as the feedwater pump 1B. In this example, the failure limit value is 128 degrees F. and the expected data value is 105 degrees F., so the numerator is determined to be the difference of 23 degrees F.

The system 500 completes the normalization of the distance to failure by dividing the determined numerator by the determined denominator, which in this example is 13 degrees F. divided by 23 degrees F., which generates the resulting 57% normalized distance to failure. This means that of the 23 degrees F. that the trend is expected to traverse from the data start value to the failure limit value, 13 degrees F. (which is 57% of 23 degrees F.) remains to be traversed. The example graph 502 shows that the unit domain (vertical lines) is 75% to failure.

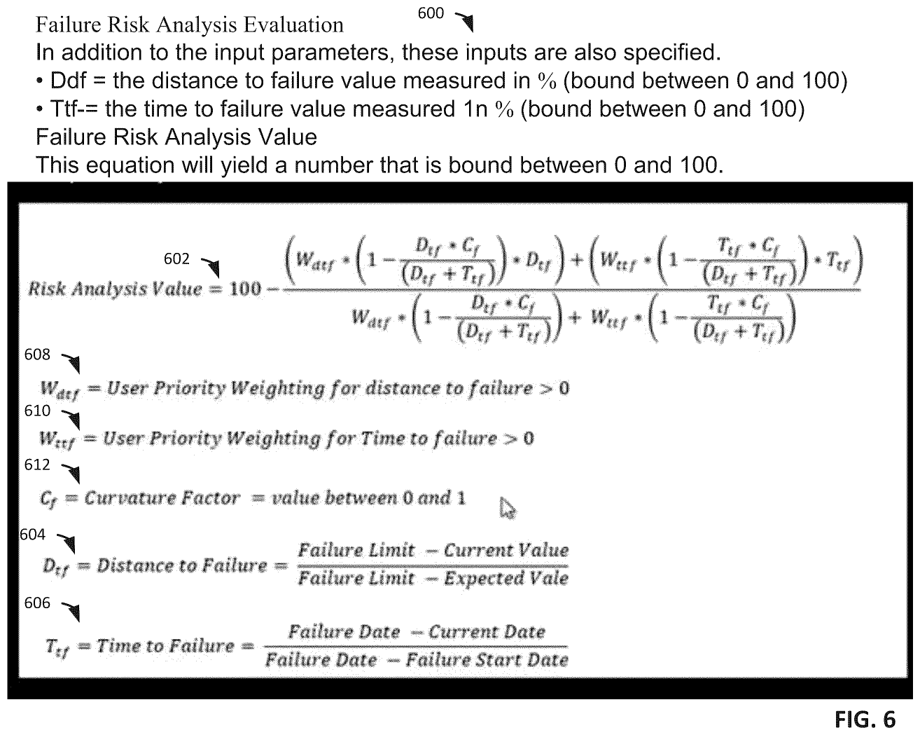

FIG. 6 illustrates an example failure risk evaluation formula 602 used by a system 600 for forecasting industrial asset failures, according to some embodiments. The system 600 analyzes the risk of failure for an industrial asset by evaluating the input parameters required by the example failure risk evaluation formula 602. The Dtf parameter 604 may be the distance to failure value measured in percentage (%), which is bound between 0% and 100%, and may be calculated based on the numerator of the failure limit (failure limit value) minus the current value (data end value), which may be divided by the denominator of the failure limit (failure limit value) minus the expected value (expected data value). The Ttf parameter 606 may be the time to failure value measured in percentage (%), which is bound between 0% and 100%, and may be calculated based on the numerator of the failure date (failure time) minus the current date (data end time), which may be divided by the denominator of the failure date (failure time) minus the failure start date (data start time). The system can use the Wdtf parameter 608, which may be the user priority weighting for the distance to failure parameter Dtf 604, the Wttf parameter 610, which may be the user priority weighting for the time to failure parameter Ttf 606, the Cf parameter 612, which may be the curvature factor, and which may be a value between 0 and 1, to evaluate the formula 602, which yields a number that is bound between 0 and 100.

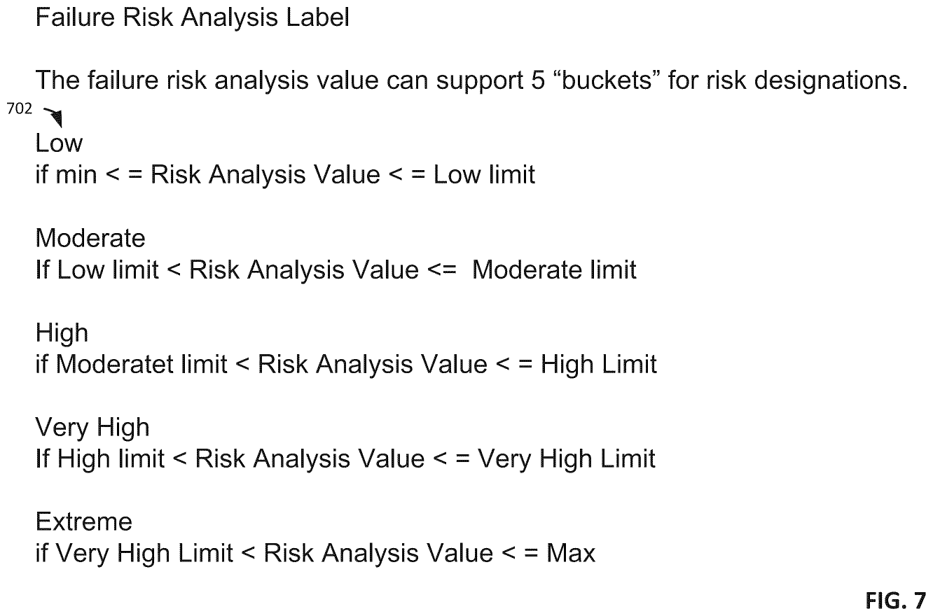

FIG. 7 illustrates example risk designation categories 702 used by a system 700 for forecasting industrial asset failures, according to some embodiments. After calculating a failure risk analysis value, which can be a number between 0 and 100, the system 700 can use a failure risk analysis value to support a number of “buckets” for risk designations or labels. For example, the risk is low if the risk analysis value is from 0 to less than 22, the risk is moderate if the risk analysis value is from 22 to less than 45, the risk is high if the risk analysis value is from 45 to less than 65, the risk is very high if the risk analysis value is from 65 to less than 85, and the risk is extreme if the risk analysis value is from 85 to 100.

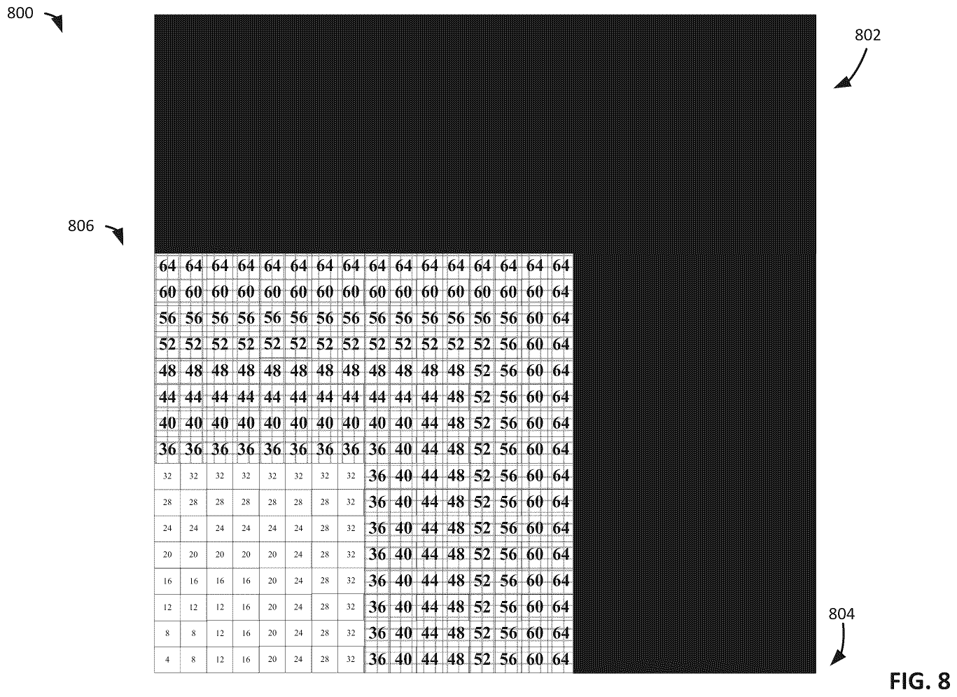

FIG. 8 illustrates an example graph 802 of the time and distance risk assessments depicted by a system 800 for forecasting industrial asset failures, according to some embodiments. Since the risk analysis value is a number from 0 to 100, the system 800 can visually depict the risk assessment by indicating the position of a risk analysis value on the graph 802. The graph 802 may be based on a horizontal time to failure axis 804 that depicts values from 0 to 100, with location 0 illustrated as green, location 100 illustrated as red, and the intermediate locations illustrated as gradually changing from green to yellow to orange to red. Similarly, the graph 802 may be based on a vertical distance to failure axis 806 that depicts values from 0 to 100, with location 0 illustrated as green, location 100 illustrated as red, and the intermediate locations illustrated as gradually changing from green to yellow to orange to red.

Collectively, if the time to failure for the feedwater pump 1B has a risk value of 52 and the distance to failure for the feedwater pump 1B has a risk value of 59, then the system 800 can position an icon representing for the feedwater pump 1B at the x-y coordinates (52, 59) on the graph 802. A human operator can easily and quickly interpret the icon's position as representing a high risk because the icon is in the midst or a region depicted as various shades of orange, as the colors for both the horizontal axis 804 for time to failure and the vertical axis 806 for distance to failure are transitioning from yellow to red. However, depicting such a graph 802 in FIG. 8 is a challenge because the numbering of 1000 locations (100 columns by 100 rows) cannot be depicted on a single drawing sheet that depicts the numbers in a font that is sufficiently large to meet drawing requirements. Similarly, depicting the graph 802 with colors transitioning from green to yellow to orange to red is a challenge due to requirements for drawings to be depicted in black and white. Consequently, the graph 802 is based on 25 horizontal locations (numbered 4, 8, 12, . . . 100) and 25 vertical locations (numbered 4, 8, 12, . . . 100) with locations 4 to 32 depicted in white, locations 36 to 64 depicted in white with black grid lines, and locations 68 to 100 depicted in black.

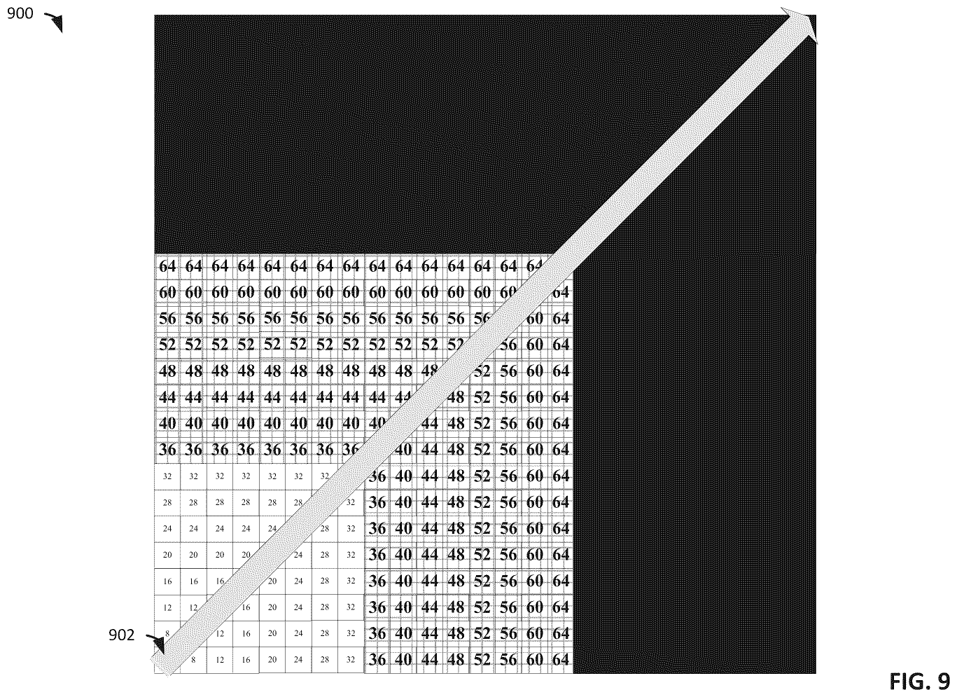

FIG. 9 shows an expected failure path for a linear trend in a graph 902 depicted by a system 900 for forecasting industrial asset failures, according to some embodiments. The trend arrow 904 in the graph 902 represents how systems that predict a trend will behave according to some embodiments. The failure trend is perfectly linear in this example.

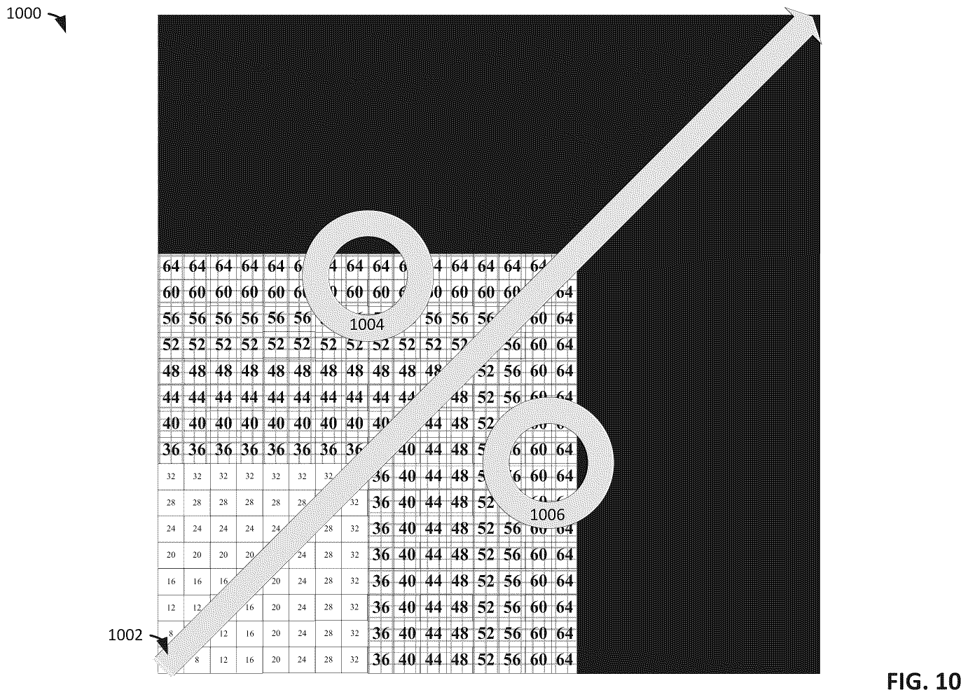

FIG. 10 illustrates real world examples of a current trend in a graph 1002's circular domains depicted by a system 1000 for forecasting industrial asset failures, according to some embodiments. As evident from the image, which includes the trend arrow 1004 and the circular icons 1006 and 1008, the system 1000 is configured to assign risk as high if either the time domain or the unit domain is within a predetermined limit. Conventional techniques do not enable proper risk assessment in the unit domain.

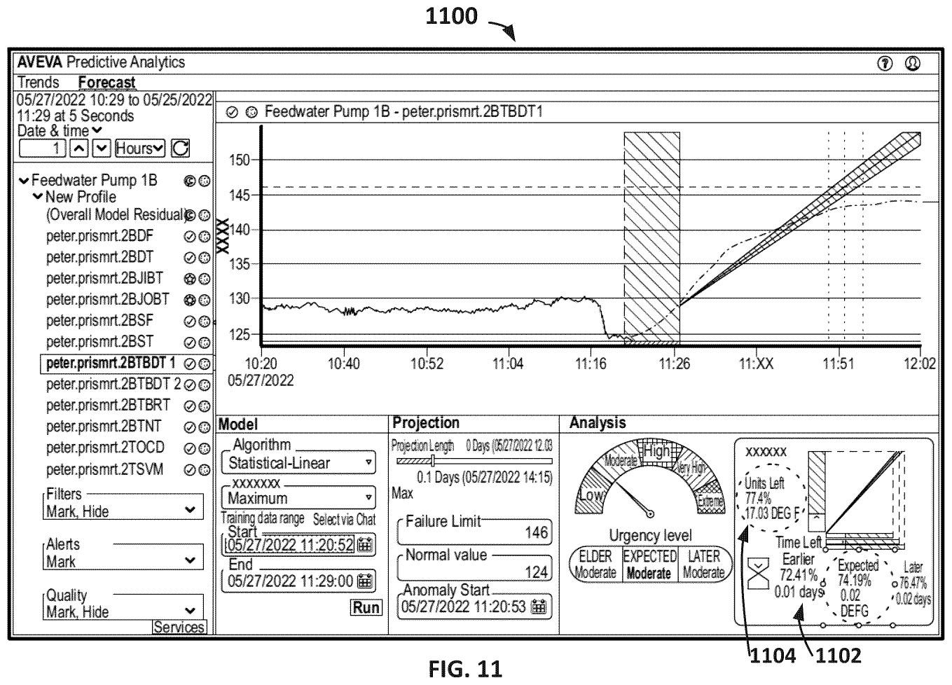

FIG. 11 illustrates an example contrast of problems with conventional systems accurately predicting failure for changing trends by a system 1100 for forecasting industrial asset failures, according to some embodiments. In some conventional systems, as the trend of one of an industrial asset's data points progresses toward the failure limit value, the slope of the data trend may change. In conventional systems, this slope change will cause the estimated time to failure to also change. This time to failure may indicate that according to current trends, the risk is now minimal because the time to failure has been extended from hours to days, for example.

However, such a conventional calculation ignores the unit (vertical) component of the data trend and how close it is to the failure edge. Because the unit component is not accounted for, conventional systems typically downgrade important issues to the point where they may no longer be a considered a priority for review. Therefore, the system 1100 enables concurrent analyses of both the time to failure 1102 and the distance to failure 1104 for a large numbers of different types of processes and accurately prioritizing the failure risk of each.

Without normalizing the unit and/or the time component, assets cannot be compared to each other because the unit values do not match. For example, the risk assessment of a temperature that is 10 degrees F. to failure and a pressure that is 100 pounds per square inch (psi) to failure cannot be compared, because the value of the numbers gives the illusion that the temperature of 10 degrees F. is automatically the higher priority because the number 10 appears to be closer to any failure limit value than the number 100 could be to any failure limit value. However, if the temperature of 10 degrees F. is far from the failure limit value and the pressure 100 psi is almost touching the failure limit value, then the pressure trend has the greater risk. In some conventional systems, only analyzing risk in the time domain does not yield this information.

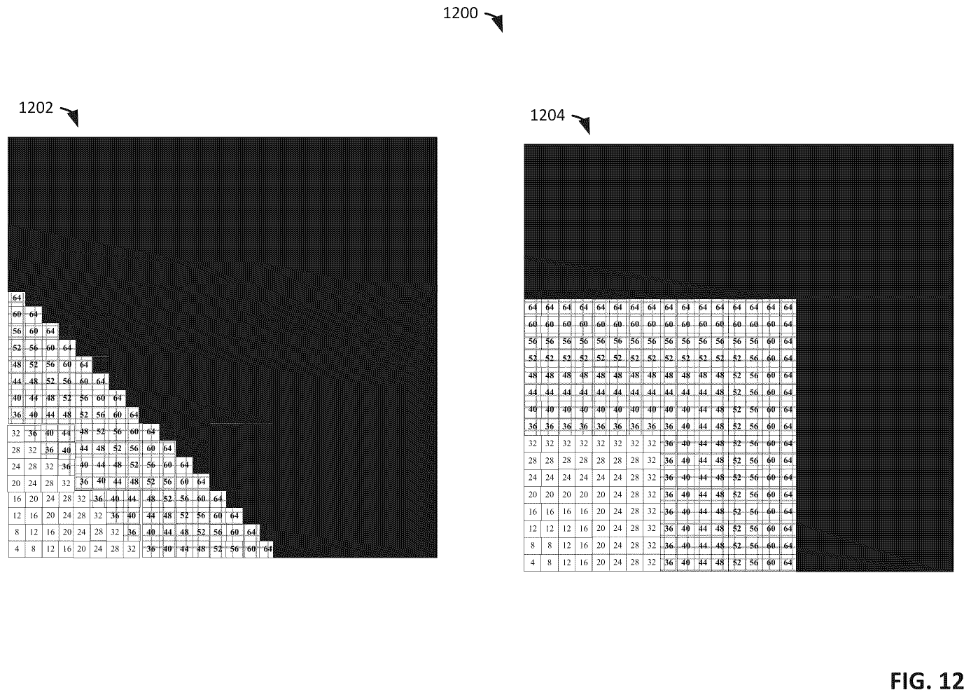

FIG. 12 shows a comparison of a left risk representation 1202 with no unit weighting (conventional system) to a right risk representation 1204 with unit weighting as defined by the system 1200 for forecasting industrial asset failures, according to some embodiments. The system 1200 can enable a user to adjust the weighting of each risk category, which enables a user to select which urgency (time or distance) should be given the greatest priority.

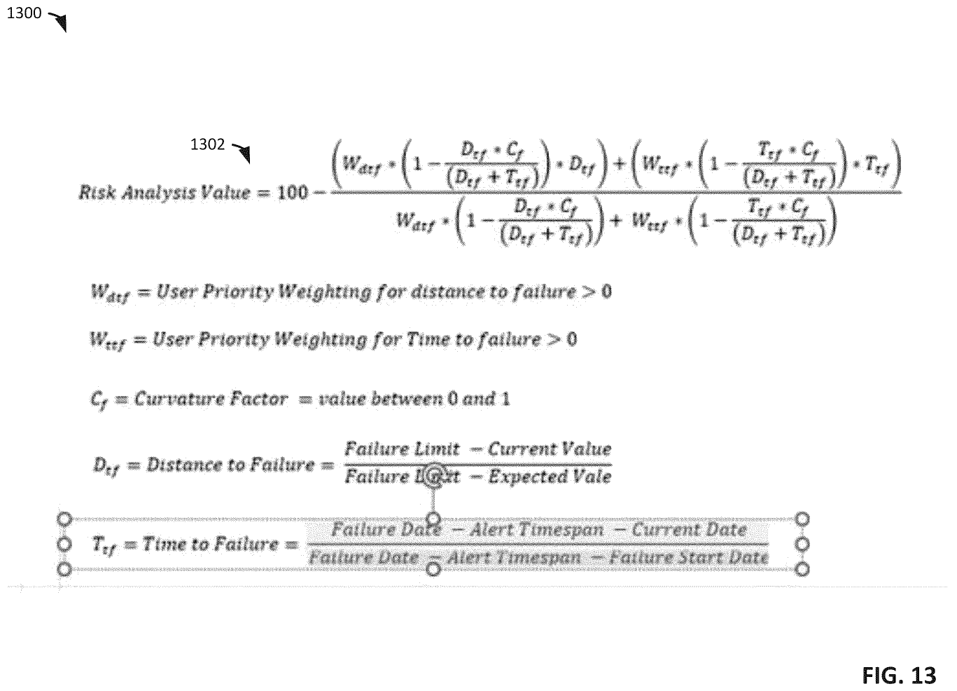

FIG. 13 shows a modification to the risk assessment equation 1302 where the time to failure includes a minimum response time component by the system 1300 for forecasting industrial asset failures, according to some embodiments. The minimum response time component 1302 increases the risk component based on how much time is needed to correct the problem associated with the risk. The modified Ttf may be the time to failure value measured in percentage (%), which is bound between 0% and 100%, and may be calculated based on the numerator of the failure date (failure time) minus the current date (data end time) and also minus the alert timespan (minimum response time), which may be divided by the denominator of the failure date (failure time) minus the failure start date (data start time), and also minus the alert timespan (minimum response time). The inclusion of the alert timespan (minimum response time) adjusts the risk value by removing the minimum required response time from the time buffer for the time to failure risk. For example, if the time to failure for the turbine 3 is 4 hours and the operator who is scheduled to be responsible for maintaining the turbines prefers to have one hour as a minimum response time when a turbine is being taken out of operation to carefully transition to another turbine that is being put into operation, then the time to failure is effectively reduced from fur hours to three hours.

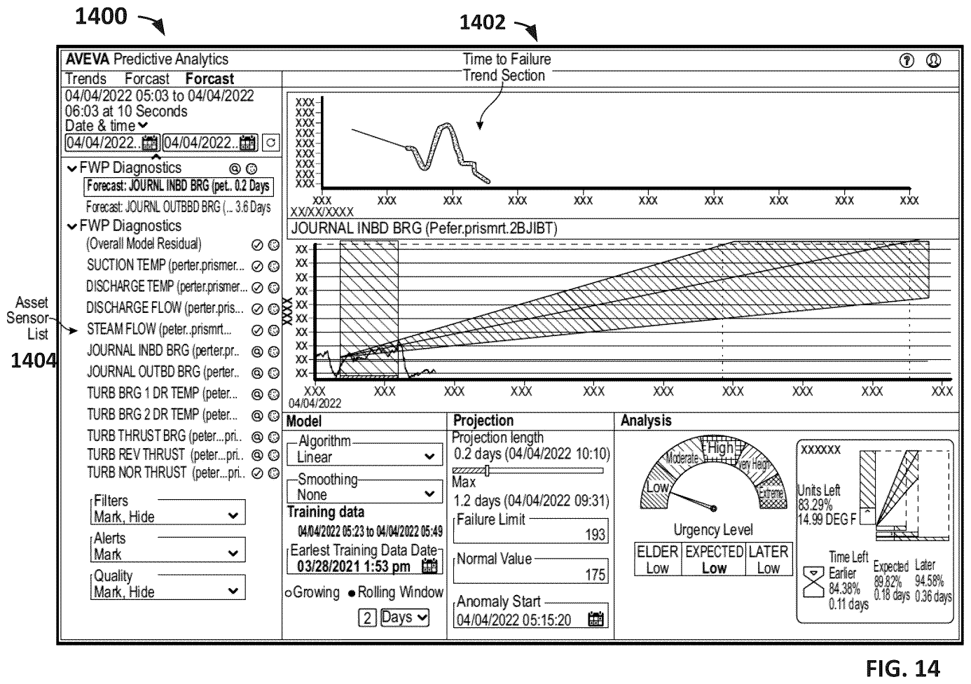

FIG. 14 illustrates an example time to failure trend section 1402 on the analytics display depicted by a system 1400 for forecasting industrial asset failures, according to some embodiments. As each portion of the trend is analyzed, the system 1400 can display a corresponding trend in a time to failure trend section 1402. The system 1400 enables confidence that assets which are not in alert are of low risk while items in alert need more attention due to the corresponding trends.

This reduces cost as enterprises do not need as many human operators monitoring individual trends for industrial assets. The system 1400 can enable a user to generate a forecast for one or more sensors in an asset sensor list section 1404 of the analytics display. Then the system 1400 can automatically select the data in the trend once the forecast model has been deployed.

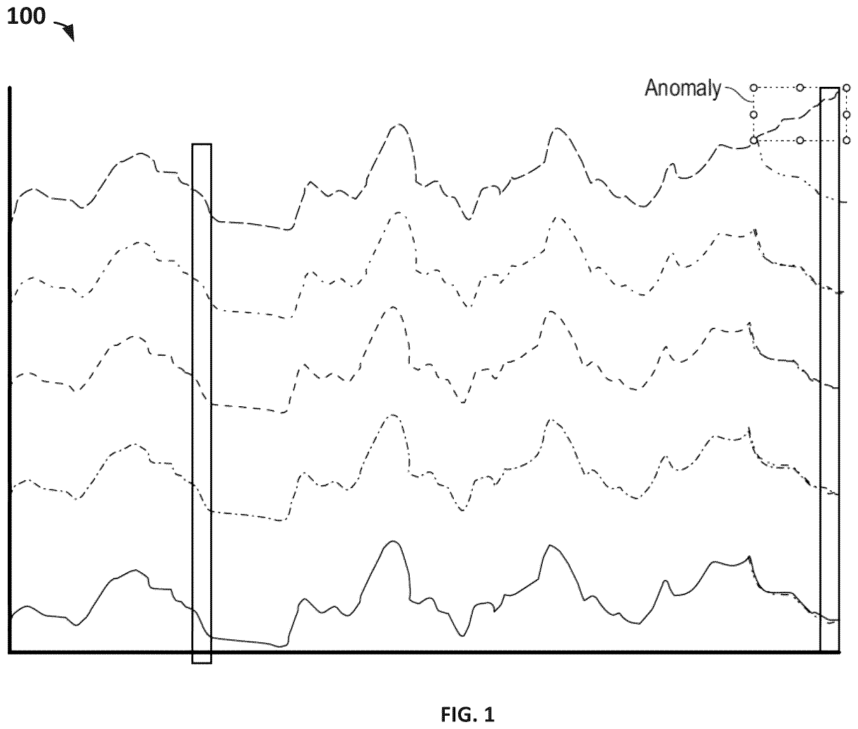

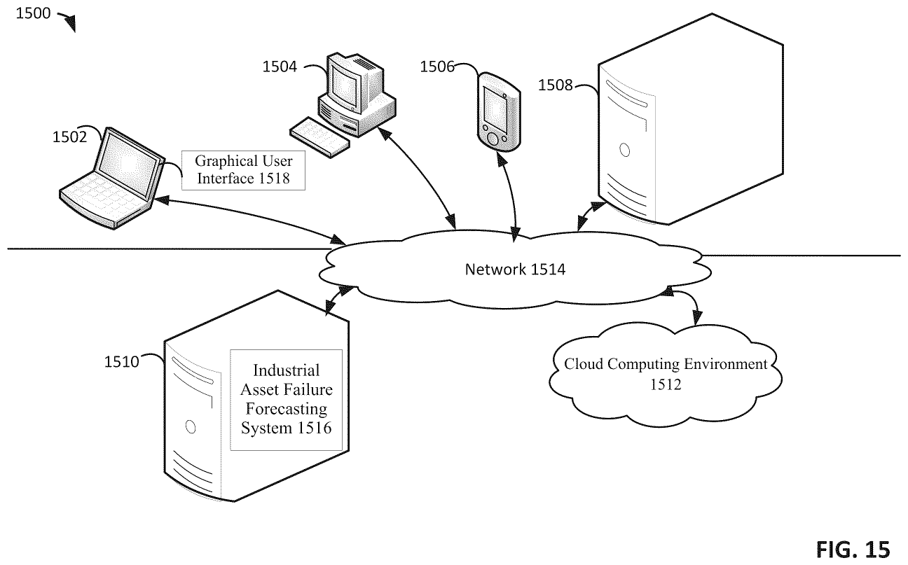

FIG. 15 illustrates a block diagram of an example system 1500 for forecasting industrial asset failures, under an embodiment. As shown in FIG. 1, the system 1500 may illustrate a cloud computing environment in which data, applications, services, and other resources are stored and delivered through shared data centers and appear as a single point of access for the users. The system 1500 may also represent any other type of distributed computer network environment in which servers control the storage and distribution of resources and services for different client users.

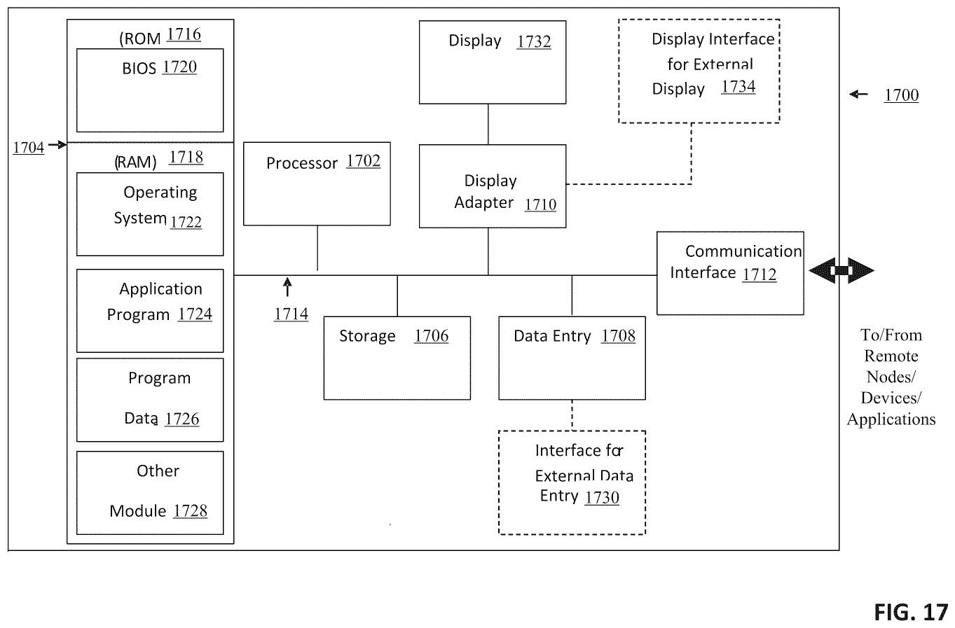

In an embodiment, the system 1500 represents a cloud computing system that includes a first client 1502, a second client 1504, a third client 1506, a fourth client 1508, and a server 1510 and an optional cloud computing environment 1512 that may be provided by a hosting company. The clients 1502-1508, the server 1510, and the cloud computing environment 1512 communicate via a network 1514. Even though FIG. 15 depicts the first client 1502 as a laptop computer 1502, the second client 1504 as a desktop computer 1504, the third client 1506 as a smart phone 1506, and the fourth client 1508 as a server, each of the system components 1502-1510 may be any type of computer system, and may each be substantially similar to the hardware device 1700 depicted in FIG. 17 and described below.

The server 1510 can host and execute an industrial asset failure forecasting system 1516, which may be accessed via a graphical user interface 1518, as depicted by FIG. 15, and/or reside on any of the clients 1502-1508. Although FIG. 15 depicts all of the industrial asset failure forecasting system 116 residing completely on the server 1510, any or all of the industrial asset failure forecasting system 1516 may reside completely on the clients 1502-1508, completely on the cloud computing environment 1512, or in any combination of partially on the clients 1502-1508, partially the server 1510, partially on the cloud computing environment 1512 and/or partially on another server which is not depicted in FIG. 15. FIG. 15 depicts the system 1500 with four clients 1502-1508, one server 1510, one cloud computing environment 1512, one network 1514, one industrial asset failure forecasting system 1516, and one graphical user interface 1518, but the system 1500 may include any number of clients 1502-1508, any number of servers 1510, any number of cloud computing environment 1512, any number of network 1514, any number of industrial asset failure forecasting system 1516, and any number of graphical user interface 1518.

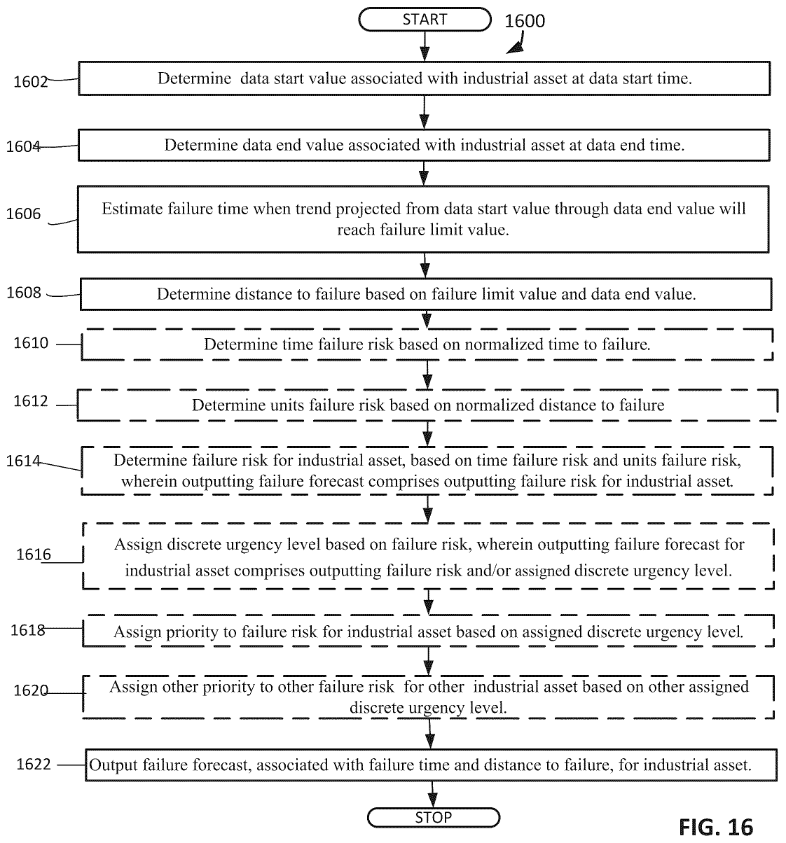

FIG. 16 is a flowchart that illustrates a computer-implemented method for forecasting industrial asset failures, under an embodiment. Flowchart 1600 depicts method acts illustrated as flowchart blocks for certain actions involved in and/or between the system elements 1502-1518 of FIG. 15.

A data start value associated with an industrial asset at a data start time is determined, block 1602. The system begins collecting data for predicting equipment failure. For example, and without limitation, this can include the industrial asset failure forecasting system 1516 determining that at noon on September 8^{th} the feedwater pump 1B had a water temperature of 144.9 degrees F.

A data start value can be a beginning number or mathematical object for an information series. An industrial asset can be a piece of equipment for the manufacture or production of products and/or services. A data start time can be a beginning chronological measure for an information series.

After determining the data start value for the industrial asset at the data start time, a data end value associated with the industrial asset at a data end time is determined, block 1604. The system completes collecting data for a prediction of equipment failure. By way of example and without limitation, this can include the industrial asset failure forecasting system 1516 determining that at noon on September 9^{th} the feedwater pump 1B has a water temperature of 145.0 degrees F. A data end value can be a final number or mathematical object for an information series. A data end time can be a final chronological measure for an information series.

Following the determining of data values at start and end times, a failure time is estimated when a trend projected from the data start value through the data end value will reach a failure limit value, block 1606. The system predicts when equipment will begin to fail. In embodiments, this can include the industrial asset failure forecasting system 1516 projecting the trend from the current water temperature of 145.0 degrees F. into the future and estimating that the feedwater pump 1B's water temperature will reach the equipment failure temperature of 146.0 degrees F. in 10 days at noon on September 19^{th}.

A failure time can be a chronological measure associated with a loss of functioning. A trend can be a general direction in which something is developing or changing A failure limit value can be a threshold number or mathematical object associated with a loss of functioning.

Having estimated a failure time based on projecting a trend from the data start and end values, a distance to failure is determined based on the failure limit value and the data end value, block 1608. The system identifies a tolerance until equipment failure. For example, and without limitation, this can include the industrial asset failure forecasting system 1516 subtracting the current temperature of 145.0 degrees F. from the projected failure temperature of 146.0 degrees F. to result in a distance to failure of 1 degree F. A distance to failure can be an interval which is between numerical values and associated with a loss of functioning.

In addition to determining a distance to failure based on the values for the failure limit and data end value, a time failure risk is optionally determined based on the normalized time to failure, which is normalized based on the data start time, the data end time, and the failure time, block 1610. The system identifies the risk of the time to failure for the equipment. By way of example and without limitation, this can include the industrial asset failure forecasting system 1516 determining that the time to failure that is remaining is 10 days from the data end time of noon on September 9^{th} to the failure time of noon on September 19^{th} out of a projected 11 days from the data start time of noon on September 8^{th} to the projected failure time at noon on September 19^{th}, which is a normalized remaining time to failure of 91% (10 days divided by 11 days). The industrial asset failure forecasting system 1516 uses the normalized remaining time to failure of 91% to assign a low urgency for a time risk failure to the maintenance request for a feedwater pump operator, because the failure risk for the feedwater pump 1B is projected to occur after a relatively long time. A time failure risk can be a chronological measure associated with a probability of a loss of functioning.

Determining the time failure risk may be based on an adjustment for a minimum response time required. For example, the industrial asset failure forecasting system 1516 takes into consideration that the operator who is scheduled to be responsible for maintaining the feedwater pumps prefers to have one hour as a minimum response time when a feedwater pump is being taken out of operation to carefully transition to another feedwater pump that is being put into operation. The industrial asset failure forecasting system 1516 uses the remaining time to the projected failure of 10 days, which is 240 hours, and subtracts the one-hour minimum response time for switching the feedwater pumps to result in a numerator of 239 hours.

Next, the industrial asset failure forecasting system 1516 uses the total time to the projected failure of 11 days, which is 264 hours, and subtracts the one-hour minimum response time for switching the feedwater pumps to result in a denominator of 263 hours. Then the industrial asset failure forecasting system 1516 divides the numerator of 239 hours by the denominator of 263 hours to result in an unchanged 91% for the normalized time to failure, which is still assigned a low urgency for the time failure risk to the maintenance request for a feedwater pump operator. An adjustment can be a small alteration made to achieve a desired fit, appearance, or result. A minimum response time can be a smallest chronological measure for a reaction.

Similar to determining the time failure risk, a units failure risk is optionally determined based on a normalized distance to failure, wherein the distance to failure is normalized based on an expected data value, the data end value, and the failure limit value, block 1612. The system identifies the risk of the distance to failure for the equipment. In embodiments, this can include the industrial asset failure forecasting system 1516 using the remaining distance to failure, which is 1.0 degrees F. from the current temperature of 145.0 degrees F. to the failure limit value of 146.0 at noon on September 19^{th}, out of a projected total distance to failure of 22.0 degrees F. from the expected temperature of 124.0 degrees F. to the projected failure temperature of 146.0 degrees F., to calculate a normalized distance to failure of 5% (1.0 degrees F. divided by 22.0 degrees F.). Then the industrial asset failure forecasting system 1516 uses the normalized distance to failure of 5% to assign an extreme urgency for the units failure risk to the maintenance request for a feedwater pump operator. A units failure risk can be a standard for a quantity and associated with a probability of a loss of functioning. An expected data value can be a probable number or mathematical object for an information series.

Having determined a time failure risk and a units failure risk, a failure risk is optionally determined for an industrial asset, based on the time failure risk and the units failure risk, wherein outputting the failure forecast comprises outputting the failure risk for the industrial asset, block 1614. The system combines probabilities of equipment failure. For example, and without limitation, this can include the industrial asset failure forecasting system 1516 combining the low urgency assigned to the time risk failure for the feedwater pump 1B, with the extreme urgency assigned to the units failure risk for the feedwater pump 1B to result in assigning a high urgency to the failure risk for the feedwater pump 1B. When outputting the failure forecast, the industrial asset failure forecasting system 1516 outputs the high urgency assigned to the failure risk for the feedwater pump 1B. A failure risk can be a probability of a loss of functioning.

Determining the failure risk may be based on a time weight assigned by a system user to the time failure risk and/or on a units weight assigned by the system user to the units failure risk. For example, rather than combining the time risk failure for the feedwater pump 1B with the units failure risk for the feedwater pump 1B by using default weights which are the same for the time risk failure and the units risk failure, the industrial asset failure forecasting system 1516 can use weights assigned by a system user to combine the time risk failure with the units failure risk for the feedwater pump 1B. If a system user assigned a time weight of 0.50 to the time risk failure and a units weight of 2.0 to the units failure risk, then the industrial asset failure forecasting system 1516 could assign a very high urgency to the failure risk for the feedwater pump 1B because the assigned weights deemphasize the factors contributing to a low urgency for the time risk failure while emphasizing the factors that emphasize the extreme urgency for the units risk failure.

A time weight can be a magnitude of importance associated with a chronological measure. A system user can be a person who operates a computer. A units weight can be a magnitude of importance associated with a standard for a quantity.

After determining a failure risk, one of a plurality of discrete urgency levels is optionally identified based on the failure risk, wherein outputting the failure risk for the industrial asset comprises outputting the identified one of the plurality of discrete urgency levels, block 1616. The system identifies urgency levels for probabilities of loss of functioning. By way of example and without limitation, this can include the industrial asset failure forecasting system 1516 assigning a high urgency to the failure risk for the feedwater pump 1B. When outputting the failure forecast, the industrial asset failure forecasting system 1516 outputs the high urgency for the failure risk for the feedwater pump 1B. Discrete urgency levels can be distinct categories for requiring action.

Following the identification of one of the urgency levels, a priority is optionally assigned to the failure risk for the industrial asset based on the assigned corresponding one of the plurality of discrete urgency levels, block 1618. The system assigns priorities to probabilities of loss of functioning. In embodiments, this can include the industrial asset failure forecasting system 1516 assigning the highest priority to the failure risk that was also assigned the extreme urgency for the feedwater pump 1B. A priority can be the order in which processes are scheduled and executed based on their assigned levels of importance or urgency.

Having assigned a priority to a failure risk for an industrial asset, another priority is optionally assigned to another failure risk for another industrial asset, block 1620. The system prioritizes all industrial assets' probabilities of loss of functioning. For example, and without limitation, this can include the industrial asset failure forecasting system 1516 assigning an overall priority of moderate to the failure risk for a steam turbine 4. Even though the turbine's failure risk is based on pressure data and the pump's failure risk is based on temperature data, the normalization of the time to failure and the distance to failure of the steam turbine 3 and the feedwater pump 1B enables an operator to easily compare the overall priority, the urgency level, and the failure risk of the steam turbine 3 and the feedwater pump 1B.

After determining the failure time and the distance to failure, a failure forecast, associated with the failure time and the distance to failure, is output for the industrial asset, block 1622. The system outputs priorities for predicted probabilities of loss of functioning. By way of example and without limitation, this can include the industrial asset failure forecasting system 1516 outputting the highest priority for the failure risk for the feedwater pump 1B, due to the extreme urgency assigned to the distance to failure for the temperature of the feedwater pump 1B, and despite the low urgency assigned to the time to failure for the feedwater pump 1B. A failure forecast can be a prediction associated with a loss of functioning.

Although FIG. 16 depicts the blocks 1602-1622 occurring in a specific order, the blocks 1602-1622 can occur in another order. In other implementations, each of the blocks 1602-1622 can also be executed in combination with other blocks and/or some blocks may be divided into a different set of blocks.

An exemplary hardware device in which the subject matter may be implemented shall be described. Those of ordinary skill in the art will appreciate that the elements illustrated in FIG. 17 can vary depending on the system implementation. With reference to FIG. 17, an exemplary system for implementing the subject matter disclosed herein includes a hardware device 1700, including a processing unit 1702, a memory 1704, a storage 1706, a data entry module 1708, a display adapter 1710, a communication interface 1712, and a bus 1714 that couples elements 1704-1712 to the processing unit 1702.

The bus 1714 can comprise any type of bus architecture. Examples include a memory bus, a peripheral bus, a local bus, etc. The processing unit 1702 is an instruction execution machine, apparatus, or device and can comprise a microprocessor, a digital signal processor, a graphics processing unit, an application specific integrated circuit (ASIC), a field programmable gate array (FPGA), etc. The processing unit 1702 may be configured to execute program instructions stored in the memory 1704 and/or the storage 1706 and/or received via the data entry module 1708.

The memory 1704 can include a read only memory (ROM) 1716 and a random-access memory (RAM) 1718. The memory 1704 may be configured to store program instructions and data during operation of the hardware device 1700. In various embodiments, the memory 1704 can include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 1704 can also include nonvolatile memory technologies such as nonvolatile flash RAM (NVRAM) or ROM. It is contemplated that the memory 1704 can include a combination of technologies such as the foregoing, as well as other technologies not specifically mentioned. When the subject matter is implemented in a computer system, a basic input/output system (BIOS) 1720, containing the basic routines that help to transfer information between elements within the computer system, such as during start-up, is stored in the ROM 1716.

The storage 1706 can include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 1700.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like can also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 1706, the ROM 1716 or the RAM 1718, including an operating system 1722, one or more applications programs 1726, program data 1726, and other program modules 1728. A user can enter commands and information into the hardware device 1700 through data entry module 1708. The data entry module 1708 can include mechanisms such as a keyboard, a touch screen, a pointing device, etc.

Other external input devices (not shown) are connected to the hardware device 1700 via an external data entry interface 1710. By way of example and not limitation, external input devices can include a microphone, joystick, game pad, satellite dish, scanner, or the like. External input devices can include video or audio input devices such as a video camera, a still camera, etc. The data entry module 1708 may be configured to receive input from one or more users of the hardware device 1700 and to deliver such input to the processing unit 1702 and/or the memory 1704 via the bus 1714.

A display 1712 is also connected to the bus 1714 via the display adapter 1710. The display 1712 may be configured to display output of the hardware device 1700 to one or more users. A given device such as a touch screen, for example, can function as both the data entry module 1708 and the display 1712. External display devices can also be connected to the bus 1714 via the external display interface 1734. Other peripheral output devices, not shown, such as speakers and printers, may be connected to the hardware device 1700.

The hardware device 1700 can operate in a networked environment using logical connections to one or more remote nodes (not shown) via the communication interface 1712. The remote node may be another computer, a server, a router, a peer device or other common network node, and typically includes many or all of the elements described above relative to the hardware device 1700. The communication interface 1712 can interface with a wireless network and/or a wired network. Examples of wireless networks include, for example, a BLUETOOTH network, a wireless personal area network, a wireless 802. 21 local area network (LAN), and/or wireless telephony network (e.g., a cellular, PCS, or GSM network).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. The communication interface 1712 can include logic configured to support direct memory access (DMA) transfers between the memory 1704 and other devices.

In a networked environment, program modules depicted relative to the hardware device 1700, or portions thereof, may be stored in a remote storage device, such as, for example, on a server. It will be appreciated that other hardware and/or software to establish a communications link between the hardware device 1700 and other devices may be used.

It should be understood that the arrangement of the hardware device 1700 illustrated in FIG. 17 is but one potential implementation and that other arrangements are feasible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 1700.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 17.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter can also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included may be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms: Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example. As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system.

The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general-purpose computer selectively activated or configured by one or more computer programs stored in the computer memory, cache, or obtained over a network. When data is obtained over a network the data may be processed by other computers on the network, e.g., a cloud of computing resources.

The embodiments of the system can also be defined as a machine that transforms data from one state to another state. The data can represent an article, that may be represented as an electronic signal and electronically manipulate data. The transformed data can, in some cases, be visually depicted on a display, representing the physical object that results from the transformation of data. The transformed data may be saved to storage generally, or in particular formats that enable the construction or depiction of a physical and tangible object. The manipulation may be performed by a processor.

In such an example, the processor thus transforms the data from one thing to another. Still further, some embodiments include methods that may be processed by one or more machines or processors that may be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations may be performed in between operations, operations may be adjusted so that they occur at slightly different times, and/or operations may be distributed in a system which allows the occurrence of the processing operations at various intervals associated with the processing, as long as the processing of the overlay operations are performed in the desired way and result in the desired system output. It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

What is claimed is:

1. A system for forecasting industrial asset failures, the system comprising:
one or more processors; and
a non-transitory computer readable medium storing a plurality of instructions, which when executed, cause the one or more processors to:
determine a data start value associated with an industrial asset at a data start time;
determine a data end value associated with the industrial asset at a data end time;
estimate a failure time when a trend projected from the data start value through the data end value will reach a failure limit value;
determine a distance to failure based on the failure limit value and the data end value; and
output a failure forecast, associated with the failure time and the distance to failure, for the industrial asset.

2. The system of claim 1, wherein outputting the failure forecast comprises outputting a time to failure, which is based on the failure time and the data end time, and which is normalized based on the data start time, the data end time, and the failure time, and the distance to failure is normalized based on an expected data value, the data end value, and the failure limit value.

3. The system of claim 2, wherein the plurality of instructions further causes the processor to:
determine a time failure risk based on the normalized time to failure;
determine a units failure risk based on the normalized distance to failure; and
determine a failure risk for the industrial asset, based on the time failure risk and the units failure risk, wherein outputting the failure forecast comprises outputting the failure risk for the industrial asset.

4. The system of claim 3, wherein determining the failure risk for the industrial asset, based on the time failure risk and the units failure risk, is further based on at least one of a time weight assigned by a system user to the time failure risk or a units weight assigned by the system user to the units failure risk.

5. The system of claim 3, wherein determining the time failure risk is based on an adjustment for a minimum response time required.

6. The system of claim 3, wherein the plurality of instructions further causes the processor to assign a corresponding one of a plurality of discrete urgency levels to the failure risk, wherein outputting the failure risk for the industrial asset comprises outputting the assigned corresponding one of the plurality of discrete urgency levels.

7. The system of claim 6, wherein the plurality of instructions further causes the processor to:
assign a priority to the failure risk for the industrial asset based on the assigned corresponding one of the plurality of discrete urgency levels; and
assign another priority to another failure risk for another industrial asset based on another one of the plurality of discrete urgency levels.

8. A computer-implemented method for forecasting industrial asset failures, the computer-implemented method comprising:
determining a data start value associated with an industrial asset at a data start time;
determining a data end value associated with the industrial asset at a data end time;
estimating a failure time when a trend projected from the data start value through the data end value will reach a failure limit value;
determining a distance to failure based on the failure limit value and the data end value; and
outputting a failure forecast, associated with the failure time and the distance to failure, for the industrial asset.

9. The computer-implemented method of claim 8, wherein outputting the failure forecast comprises outputting a time to failure, which is based on the failure time and the data end time, and which is normalized based on the data start time, the data end time, and the failure time, and the distance to failure is normalized based on an expected data value, the data end value, and the failure limit value.

10. The computer-implemented method of claim 9, wherein the computer-implemented method further comprises:
determining a time failure risk based on the normalized time to failure;
determining a units failure risk based on the normalized distance to failure; and
determining a failure risk for the industrial asset, based on the time failure risk and the units failure risk, wherein outputting the failure forecast comprises outputting the failure risk for the industrial asset.

11. The computer-implemented method of claim 10, wherein determining the failure risk for the industrial asset, based on the time failure risk and the units failure risk, is further based on at least one of a time weight assigned by a system user to the time failure risk or a units weight assigned by the system user to the units failure risk.

12. The computer-implemented method of claim 10, wherein determining the time failure risk is based on an adjustment for a minimum response time required.

13. The computer-implemented method of claim 10, wherein the computer-implemented method further comprises assign a corresponding one of a plurality of discrete urgency levels to the failure risk, wherein outputting the failure risk for the industrial asset comprises outputting the assigned corresponding one of the plurality of discrete urgency levels.

14. The computer-implemented method of claim 13, wherein the computer-implemented method further comprises:
assigning a priority to the failure risk for the industrial asset based on the assigned corresponding one of the plurality of discrete urgency levels; and
assigning another priority to another failure risk for another industrial asset based on another one of the plurality of discrete urgency levels.

15. A computer program product, comprising a non-transitory computer-readable medium having a computer-readable program code embodied therein to be executed by one or more processors, the program code including instructions to:
determine a data start value associated with an industrial asset at a data start time; determine a data end value associated with the industrial asset at a data end time;
estimate a failure time when a trend projected from the data start value through the data end value will reach a failure limit value;
determine a distance to failure based on the failure limit value and the data end value; and
output a failure forecast, associated with the failure time and the distance to failure, for the industrial asset.

16. The computer program product of claim 15, wherein outputting the failure forecast comprises outputting a time to failure, which is based on the failure time and the data end time, and which is normalized based on the data start time, the data end time, and the failure time, and the distance to failure is normalized based on an expected data value, the data end value, and the failure limit value.

17. The computer program product of claim 16, wherein the program code includes further instructions to:
determine a time failure risk based on the normalized time to failure;
determine a units failure risk based on the normalized distance to failure; and
determine a failure risk for the industrial asset, based on the time failure risk and the units failure risk, wherein outputting the failure forecast comprises outputting the failure risk for the industrial asset.

18. The computer program product of claim 17, wherein determining the failure risk for the industrial asset, based on the time failure risk and the units failure risk, is further based on at least one of a time weight assigned by a system user to the time failure risk or a units weight assigned by the system user to the units failure risk.

19. The computer program product of claim 17, wherein determining the time failure risk is based on an adjustment for a minimum response time required.

20. The computer program product of claim 17, wherein the program code includes further instructions to;
assign a corresponding one of a plurality of discrete urgency levels to the failure risk, wherein outputting the failure risk for the industrial asset comprises outputting the assigned corresponding one of the plurality of discrete urgency levels;
assign a priority to the failure risk for the industrial asset based on the assigned corresponding one of the plurality of discrete urgency levels; and
assign another priority to another failure risk for another industrial asset based on another one of the plurality of discrete urgency levels.
